(19) United States
(12) Patent Application Publication
(10) Pub. No.: US 2010/0116457 A1
(43) Pub. Date: May 13, 2010

(54) METHOD FOR PRODUCING A LATENT HEAT STORAGE MATERIAL

(75) Inventors: Oswin Öttinger, Meitingen (DE); Martin Christ, Augsburg (DE); Jörg F. Friedrich, Erkner (DE); Reinhard Mach, Berlin (DE); Heinz-Eberhard Maneck, Wildau (DE); Asmus Meyer-Plath, Potsdam (DE)

Correspondence Address: LERNER GREENBERG STEMER LLP, P O BOX 2480, HOLLYWOOD, FL, 33022-2480, US

(73) Assignees: SGL CARBON SE, Wiesbaden (DE); BUNDESANSTALT FUR MATERIALFORSCHUNG UND -Prufung, Berlin (DE)

(21) Appl. No.: 12/614,934

(22) Filed: Nov. 9, 2009

Related U.S. Application Data
(63) Continuation of application No. PCT/EP2008/056068, filed on May 16, 2008.

(30) Foreign Application Priority Data
May 16, 2007 (DE) 10 2007 023 315.0

(51) Int. Cl. F28D 20/02; H05H 1/24

(52) U.S. Cl. 165/10; 264/483

(57) ABSTRACT

A method for producing a latent heat storage material from a graphitic starting material selected from the group consisting of natural graphite, expanded graphite, and/or graphite fibers, and from a phase-changing material selected from the group consisting of sugar alcohols, water, organic acids and the mixtures thereof, aqueous salt solutions, salt hydrates, mixtures of salt hydrates, salt hydrates with paraffins, inorganic and organic salts and eutectic salt mixtures, clathrates and alkali metal hydroxides, as well as mixtures of these materials. The graphitic starting material is treated with a plasma before being impregnated with the phase-changing material. A latent heat storage material is produced according to the method.

The invention relates to a process for producing a latent heat storage material from a graphitic starting material selected from the group consisting of natural graphite, expanded graphite and graphite fibers and a phase change material selected from the group consisting of sugar alcohols, water, organic acids and mixtures thereof, aqueous salt solutions, salt hydrates, mixtures of salt hydrates, salt hydrates and paraffins, inorganic and organic salts and eutectic salt mixtures, clathrates and alkali metal hydroxides and also mixtures of these materials and also a process for producing a latent heat store and a latent heat storage material produced by the process.

Phase change materials are suitable for the storage of heat energy in the form of latent heat. In this context, phase change materials are materials which undergo a phase transformation, e.g. a conversion of the solid phase into the liquid phase (melting) or the liquid phase into the solid phase (solidification) or a transition between a low-temperature modification and a high-temperature modification, on introduction or removal of heat. If heat is introduced into or withdrawn from a phase change material, its temperature remains constant on reaching the phase transformation point until the material is completely transformed. The heat introduced or removed during the phase transformation, which does not bring about a temperature change in the material, is referred to as latent heat.

A disadvantage of phase change materials for practical use as heat stores is the low thermal conductivity of these materials. As a result, the charging and discharging of the heat stores proceeds relatively slowly.

The charging and discharging time of latent heat stores can be reduced by introducing the phase change material into a matrix composed of a material having a high thermal conductivity. For example, DE-A 196 30 073 has proposed impregnating a porous matrix composed of graphite with a “solid-liquid” phase change material present in the liquid state. The impregnation can be effected by means of dipping processes, vacuum processes or vacuum-pressure processes.

US-A1 2002 0016505 has proposed mixing an auxiliary which has a high thermal conductivity, for example metal or graphite powder, into the phase change material. Specifically, it is indicated in Example 2 of this document that 2 g of the phase change material didodecylammonium chloride are milled together with 2 g of synthetic graphite KS6 and pressed to give a shaped body. The advantages of this procedure are the variable shaping by means of economical shaping processes which can be employed industrially, e.g. tableting or extrusion, and the possibility of processing solid phase change materials and phase change materials containing solid additives, e.g. nucleating agents. As an alternative, use as bed in a latent heat storage container having heat-exchange profiles running through it is possible.

In contrast to the graphite matrix impregnated with the phase change material of DE-A 196 30 073, the particles of the thermally conductive auxiliary in the mixtures described in US-A1 2002 0016505 do not form a conductive framework enclosing the phase change material. The thermal conductivity is therefore inevitably lower in the latter case. A considerable disadvantage of the use of metal turnings or synthetic graphite powder as thermally conductive additives is therefore that relatively high proportions of the thermally conductive auxiliary are necessary to achieve a significant increase in the thermal conductivity of the latent heat storage material (cf. the abovementioned example in US-A1 2002 00 16 505). This reduces the energy density of the latent heat store.

The document EP 1 416 027 A discloses latent heat storage materials with addition of expanded graphite as thermally conductive auxiliary. It was found that even relatively small proportions by volume (from 5%) of expanded graphite give a significant increase in the thermal conductivity. The addition of a shape-stabilizing material was not necessary. The advantages of this latent heat storage material with an addition of expanded graphite over a latent heat storage material having the same proportion by volume of synthetic graphite can be attributed to the peculiarities of the nature, structure and morphology of expanded graphite.

The crystal structure of expanded graphite corresponds far more closely to the ideal graphite layer structure than does the structure in the more isotropic particles of most synthetic graphites. The thermal conductivity of expanded graphite is therefore higher.

Further characteristics of expanded graphite are the low bulk density and the high aspect ratio of the particles. It is known that the percolation threshold, i.e. the critical proportion by volume of particles in a composite which is necessary for the formation of continuous conduction paths, is lower in the case of particles having a low packing density and a high aspect ratio than in the case of more densely packed particles having a lower aspect ratio and the same chemical composition. The conductivity is therefore significantly increased by even relatively small proportions by volume of expanded graphite.

The known latent heat storage materials, in particular those which are produced by infiltration of porous graphite structures with liquid polar phase change materials, have a residual pore volume which cannot be filled with phase change material, so that, based on the volume, the maximum possible heat storage capability is not achieved.

It is an object of the present invention to provide a process for producing a latent heat storage material which reduces the residual pore volume in the latent heat storage material produced, particularly when using polar phase change materials, or, in other words, which increases the degree of fill with phase change material in the resulting latent heat storage material at a constant graphite content. A further object of the invention is to provide a process for producing latent heat stores and the latent heat storage materials obtained according to the invention.

The object is achieved by impregnating a graphitic starting material selected from the group consisting of natural graphite, expanded graphite and graphite fibers with a phase change material selected from the group consisting of sugar alcohols, water, organic acids and mixtures thereof, aqueous salt solutions, salt hydrates, mixtures of salt hydrates, salt hydrates with paraffins, inorganic and organic salts and eutectic salt mixtures, clathrates and alkali metal hydroxides and also mixtures of these materials, wherein the graphitic starting material is treated in a plasma process before densification and impregnation with the phase change material.

It has surprisingly been found that functional oxygen groups generated on graphite in a plasma can, unlike the oxygen groups generated by thermal oxidation, have a very high long-term stability.

Further advantageous embodiments of the invention are defined in claims 2 to 24. The individual features and preferences of the invention can be derived from the following detailed description of the invention and the examples.

Although the generation of functional groups on the surface of graphitic materials, in particular on the surface of electrodes composed of pyrographite is known from the document “Introduction of functional groups onto carbon electrodes via treatment with radiofrequency plasmas” by John F. Evans and Theodore Kuwana, Analytical Chemistry, Vol. 51, pages 358-365, the generation of the functional groups described there is for the purpose of modifying the conductivity and semiconductivity by attachment of chiral, electroactive and photosensitive groups.

To be able to infiltrate expanded graphite with a liquid phase change material, the graphite firstly has to be predensified. For example, it is known from DE-A 196 30 073 that a porous matrix composed of expanded graphite has to be predensified to a density of at least 75 g/l before impregnation with a phase change material present in the liquid state. For this purpose, naturally occurring graphite platelets are, for example, as described in document DE 26 088 66 A1, intercalated with a sulfuric acid/hydrogen peroxide mixture, washed until neutral, dried and expanded at temperatures of about 1000° C.

To improve the infiltration capability of expanded graphite produced in this way, the resulting expanded graphite having a bulk density of from 0.5 to 15 g/l, preferably from 2 to 6 g/l, is subsequently surface-modified by means of a plasma in a process gas. The plasma serves as source of high-energy species, for example rotationally, vibrationally and/or electronically excited molecules or radicals, electronically excited atoms or ions of the surrounding gas atmosphere and also electrons and photons. If these species have sufficient enthalpy, they activate chemical bonds of the graphite so that rupture of bonds and formation of reaction products with species of the process gas, which appear in the form of functional surface groups, can occur.

The transfer of energy from an energy source to the atoms or molecules of a process gas and the graphite surface can be brought about by ions, electrons, electric or electromagnetic fields including radiation. Industrially, excitation of a gas to a plasma can be achieved in a very large pressure range, preferably from 0.1 to 500 000 Pa, particularly preferably in the low-pressure range from 1 to 100 Pa or in the high-pressure range from 50 000 to 150 000 Pa, preferably in the atmospheric pressure range, by means of a DC gas discharge or AC gas discharge, a high-energy electromagnetic radiation field as produced, for example, by a microwave source or a laser, or, alternatively, an electron or ion source. The plasma can here be operated continuously or discontinuously. The neutral gas component can, depending on the way in which the plasma is excited, be cold, i.e. in the range below about 700 K as in the case of a low-temperature plasma, or hot, i.e. in the range above about 700 K as in the case of a thermal plasma.

The graphite powder which has been expanded and subsequently treated in a plasma is pressed to form shaped bodies having bulk densities, i.e. mass per unit body volume, of from 0.03 g/cm³ to 1.0 g/cm³. The shaped bodies are evacuated to a pressure of 3 Pa and subsequently impregnated with a liquid phase change material.

The inventive composites composed of graphite and phase change materials can be produced particularly advantageously by processing methods known from plastics technology for producing compounds, e.g. by kneading or granulation. Particular preference is given to processing by means of an extruder, for example a twin-screw extruder. The advantage of this process is that the phase change material is melted. The continuous mixing of the graphite into the liquid phase allows greater homogeneity to be achieved than in the case of powder mixing processes.

Compared to the use known from the prior art of expanded graphite as thermally conductive auxiliary for phase change materials, a higher degree of fill of the plasma-treated graphitic starting material is achieved by means of the present invention. Both pulverulent and precompressed materials can be used here. In the case of plasma-treated compacted starting materials which are subsequently infiltrated with the phase change material, the continuous graphite framework leads to better thermal conductivity of the bodies obtained, with the intrinsically poor infiltratability of the graphitic starting materials with polar phase change materials being reduced. In the production of latent heat storage materials by compounding of the plasma-treated flocculent graphitic starting materials with polar phase change materials, the tendency to running-out, i.e. demixing of graphitic material and the phase change material due to the thermally induced change between solid and liquid state of the phase change material which takes place during use, is reduced.

In an advantageous embodiment of the present invention, mixtures comprising graphite flocs and expanded graphite are added as thermally conductive auxiliary to the phase change material. Selection of the ratio of graphite flocs to expanded graphite enables a person skilled in the art to set a specific bulk density of the graphite in order to achieve a very high thermal conductivity at a very low graphite content of the latent heat storage material and a very good processibility of the graphite mixture.

In the latent heat storage materials of the invention, it is possible to use all phase change materials which are inert toward graphite in the use temperature range. The process of the invention for producing latent heat stores allows the use of various types of phase change materials. The phase change can be either a transition between liquid phase and solid phase or a transition between various solid phases. The phase transformation temperatures of the phase change materials suitable for the latent heat storage material of the invention are in the range from −100° C. to +500° C. In the case of phase transformation temperatures above 500° C., increased care has to be taken to protect the graphite against oxidative attack by atmospheric oxygen. Suitable phase change materials are, for example, sugar alcohols, gas hydrates, water, aqueous solutions of salts, salt hydrates, mixtures of salt hydrates, salt hydrates with paraffins, salts (in particular chlorides and nitrates) and eutectic mixtures of salts, alkali metal hydroxides and also mixtures of a plurality of the abovementioned phase change materials, for example mixtures of salts and alkali metal hydroxides. Typical salt hydrates suitable as phase change material are calcium chloride hexahydrate and sodium acetate trihydrate.

The choice of the phase change material is made according to the temperature range in which the latent heat store is used.

Auxiliaries, e.g. nucleating agents to prevent supercooling during the solidification process, can be added to the phase change material if required. The proportion by volume of the nucleating agent in the latent heat storage material should not exceed 2% since the proportion by volume of the nucleating agent is at the expense of the proportion by volume of the heat-storing phase change material. Preference is given to nucleating agents which even in a low concentration significantly reduce the supercooling of the phase change material. Suitable nucleating agents are materials which have a crystal structure and a melting point similar to those of the phase change material used, for example tetrasodium diphosphate decahydrate for the phase change material sodium acetate trihydrate.

The latent heat storage materials of the invention can be used as a bed or as shaped bodies. To produce shaped bodies containing the latent heat storage material of the invention, it is possible to use various shaping processes, some of them known from plastics technology, for example pressing, extrusion and injection molding. A characteristic of these shaped bodies is strong anisotropy of the thermal conductivity since the graphite flocs become oriented perpendicular to the pressing direction or parallel to the injection or extrusion direction. The shaped bodies are either used directly as heat store or as constituent of a heat storage device.

In a pressed plate composed of the heat storage material of the invention, the thermal conductivity parallel to the plane of the plate is therefore higher than that perpendicular to the plane of the plate. The same applies to injection-molded plates if the gate or gates is/are located at one edge or a plurality of edges (end faces) of the plate. However, if a shaped body whose thermal conductivity perpendicular to the plane is greater than in the plane is produced, this can be brought about by cutting the body from a block of the latent heat storage material in which the graphite flocs are aligned in such a way that the cut surface and thus the plane of the body which has been cut off runs perpendicular to the orientation of the graphite flocs in the block. For example, the desired body can be sawn off or punched from a pressed block of the latent heat storage material having appropriate dimensions perpendicular to the pressing direction or from an extruded rod having appropriate dimensions perpendicular to the extrusion direction. A block in which the graphite flocs are aligned can also be produced by infiltrating a bed of graphite flocs in which the flocs are aligned by vibrating with a liquid phase change material and subsequently allowing this to solidify. Bodies can likewise be cut from such a block so that the plane of the cut is perpendicular to the orientation of the graphite flocs.

The anisotropy of the thermal conductivity can be exploited in the structure of the latent heat store by the shaped body from the latent heat storage material preferably being arranged in such a way that the direction in the body of greater thermal conductivity is aligned in the direction of the desired heat transfer, i.e. points toward a heat-exchange profile or an article to be heated or cooled.

In the case of applications in which this cannot be achieved, it is possible to use, as an alternative, a bed of the latent heat storage material of the invention which is introduced into a container which is insulated against the surrounding and through which heat-exchange profiles run. For this variant of the heat store, the latent heat storage material is provided as a pulverulent mixture or as free-flowing granules.

If the phase change material is present in the liquid state, the flocculent graphite particles in such a bed can be arranged essentially horizontally by stamping or vibrating. If upright heat-exchange tubes are arranged in a bed having such oriented graphite flocs, the graphite flocs which are oriented perpendicular to the heat-exchange tubes, i.e. pointing away from the tubes, allow effective conduction of the heat from the heat-exchange tubes into the interior of the heat storage material or effective conduction of the heat away from the interior of the heat storage material to the tubes. The flocculent particles of the anisotropic graphite used according to the invention enables such a horizontal arrangement in the bed to be achieved more easily than do the bulky particles of expanded graphite.

The latent heat storage material can also be produced directly in the container by filling the latter with a bed of flocculent graphite, aligning the graphite flocs horizontally by vibrating or stamping and subsequently infiltrating the bed with the liquid phase change material, with the infiltration being able to be aided by means of pressure or vacuum.

The latent heat storage materials of the invention can be used in latent heat stores, for example for the thermostating and air conditioning of rooms, buildings and vehicles, for example in the transport of temperature-sensitive goods, for the cooling of electronic components or for the storage of heat, in particular solar energy or process heat obtained in industrial processes.

The invention is illustrated below with the aid of examples.

### COMPARATIVE EXAMPLE 1

Commercially available graphite hydrogensulfate SS3 (from Sumikin Chemical Co., Ltd; Tokyo, Japan) was heated suddenly to 1000° C. The expanded material obtained in this way was densified in a uniaxial press to give cylindrical shaped bodies having a density of 0.15 g/cm³. The diameter of the shaped bodies was 90 mm, and the height was 20 mm. The mass of the shaped bodies was about 19 g. A porosity of 93% by volume was calculated from the density of expanded graphite (2.2 g/cm³).

A melt of the eutectic mixture of KNO₃ and NaNO₃ (melting point: 220° C.) was poured over the shaped bodies in a glass beaker. The glass beaker was installed in an evacuatable oven at 270° C. and the oven was evacuated for 10 minutes. The oven was subsequently vented. After 10 minutes, the shaped bodies were taken from the liquid salt melt and, after the excess salt had dripped off, weighed. The dimensions of the shaped bodies remained constant. The amount of salt taken up was determined from the increase in mass and the proportions by volume of graphite (7% by volume) and salt (24% by volume) were determined with the aid of the density of the salt (2.15 g/cm³).

### EXAMPLE 1

Commercially available graphite hydrogensulfate SS3 (from Sumikin Chemical Co., Ltd; Tokyo, Japan) was heated suddenly to 1000° C. The expanded material obtained in this way was treated with an oxidizing low-pressure radiofrequency plasma in oxygen at a pressure of 25 Pa for 15 minutes at a power of 600 W. The expanded material was subsequently, as described in Comparative example 1, pressed to give cylindrical shaped bodies and infiltrated with a eutectic melt of KNO₃ and NaNO₃. After infiltration, the proportions by volume of graphite (7% by volume) and salt (38% by volume) were determined.

### COMPARATIVE EXAMPLE 2

Shaped bodies having a density of 0.15 g/cm³ were produced from expanded graphite as described in Comparative example 1. Molten sodium acetate trihydrate (melting point: 58° C.) was poured over the shaped bodies in a glass beaker. The glass beaker was installed in an evacuatable oven at 70° C. and the oven was evacuated for 10 minutes. The oven was subsequently vented. After 10 minutes, the shaped bodies were taken from the liquid salt melt and, after the excess salt hydrate had dripped off, weighed. After infiltration, the proportions by volume of graphite (7% by volume) and salt hydrate (24% by volume) were determined.

### EXAMPLE 2

Expanded graphite was produced as described in Comparative example 2, treated in an oxidizing oxygen plasma and densified to give shaped bodies having a density of 0.15 g/cm³. These shaped bodies were infiltrated with sodium acetate trihydrate as described in Comparative example 2. After infiltration, the proportions by volume of graphite (7% by volume) and salt hydrate (40% by volume) were determined.

1-24. (canceled)

25. A method for producing a latent heat storage material from a graphitic starting material selected from the group consisting of natural graphite, expanded graphite and graphite fibers and a phase change material selected from the group consisting of sugar alcohols, water, organic acids and mixtures thereof, aqueous salt solutions, salt hydrates, salt hydrates with paraffins, mixtures of salt hydrates, inorganic and organic salts and eutectic salt mixtures, clathrates and alkali metal hydroxides and also mixtures of these materials, the method comprising the steps of:
treating the graphitic starting material with a plasma before impregnating the graphic starting material with the phase change material; and
thereafter impregnating the graphic starting material with the phase changing material.

26. The method according to claim 25, including the step of treating the graphitic starting material in plasma of an electrostatic field.

27. The method according to claim 25, including the step of treating the graphitic starting material in plasma of an electromagnetic alternating field.

28. The method according to claim 26, including the step of generating the plasma by electrostatic excitation frequencies below about 100 Hz.

29. The method according to claim 27, including the step of generating the plasma by electromagnetic excitation frequencies in a frequency range from about 100 Hz to about 10 kHz.

30. The method according to claim 27, including the step of generating the plasma by electromagnetic excitation frequencies in a radio frequency range from about 10 kHz to about 300 MHz.

31. The method according to claim 27, including the step of generating the plasma by electromagnetic excitation frequencies in a microwave range from about 300 MHz to about 300 GHz.

32. The method according to claim 27, including the step of generating the plasma by laser radiation at electromagnetic excitation frequencies above about 300 GHz.

33. The method according to claim 25, including the step of treating the graphitic starting material in a gas excited by an electron beam.

34. The method according to claim 25, including the step of treating the graphitic starting material in a gas excited by an ion beam.

35. The method according to claim 25, including the further step of adding noble gases to the plasma.

36. The method according to claim 25, including the further step of adding oxidizing process gases to the plasma.

37. The method according to claim 25, including the further step of adding reducing process gases to the plasma.

38. The method according to claim 25, including the further step of adding process gases selected from a group consisting of gases which generate nitrogen-, halogen-, silicon-, phosphorus- or sulfur-containing functional groups to the plasma.

39. The process according to claim 25, including the further step of adding at least one process gas to the plasma.

40. The method according to claim 25, including the step of producing a shaped body from the latent heat storage material by one of a plurality of processes comprising injection molding, extrusion and pressing.

41. The method according to claim 39, wherein the graphitic starting material has an average particle size in the range from about 5 μm to about 5000 μm, and including the further step of treating the graphitic starting material with a low-pressure plasma in the pressure range from about 0.1 Pa to about 5000 Pa, and mixing the graphitic starting material with the phase change material.

42. The method according to claim 25, wherein the graphitic starting material has an average particle size in the range from about 5 μm to about 5000 μm, and including the further steps of treating the graphitic starting material with a thermal plasma in a pressure range from about 5000 Pa to about 200 000 Pa, and mixing the treated graphitic starting material with the phase change material.

43. The method according to claim 41, wherein the graphitic starting material is expanded graphite.

44. A method for producing a latent heat store, comprising the steps of:
producing an expanded graphite material;
exciting the expanded graphite material by a low-pressure plasma in the pressure range from about 0.1 Pa to about 5000 Pa;
pressing the expanded graphite material to form a shaped body having a density in the range from about 0.03 g/cm³ to about 1.0 g/cm³ ; and
infiltrating the shaped body with a liquid phase change material.

45. A method for producing a latent heat store, comprising the steps of:
producing an expanded graphite material;
exciting the expanded graphite material by a thermal plasma in the pressure range from about 5000 Pa to about 200 000 Pa;
pressing the expanded graphite material to form a shaped body having a density in the range from about 0.03 g/cm³ to about 1.0 g/cm^{3;} and
infiltrating the shaped body with a liquid phase change material.

46. A latent heat store, comprising a latent heat storage material:
said latent heat storage material produced according to claim 41; and
said latent heat storage material comprising a loose bed or free-flowing granules.

47. A latent heat store, comprising a latent heat storage material:
said latent heat storage material produced according to claim 44; and
said latent heat storage material having a shaped body.

48. A latent heat storage material:
said latent heat storage material produced according to claim 25; and
said latent heat storage material containing at least one nucleating agent.
